(19) United States
(12) Patent Application Publication
(10) Pub. No.: US 2004/0013354 A1
(43) Pub. Date: Jan. 22, 2004

(54) Systems and methods for selectively routing optical signals

(76) Inventors: Jonathan Simon, Castro Valley, CA (US); Ken A. Nishimura, Fremont, CA (US); Gary B. Gordon, Saratoga, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/197,360

(22) Filed: Jul. 17, 2002

(51) Int. Cl. G02B 6/26

(52) U.S. Cl. 385/25; 385/39; 385/15

(57) ABSTRACT

Optical systems are provided. One such optical system includes a first waveguide and an optical coupler. The first waveguide propagates optical signals to a first location. The optical coupler incorporates a first component and a second component and selectively, optically communicates with the first waveguide by moving between an uncoupled position and a coupled position. In the coupled position, the optical coupler optically communicates with the first waveguide so that at least some of the optical signals from the first waveguide are redirected by the first component, then the second component, and then propagated to a second location different than the first location. Methods and other optical systems also are provided.

### FIELD OF THE INVENTION

The present invention generally relates to optics. In particular, the invention relates to systems and methods that involve routing of optical signals.

### DESCRIPTION OF THE RELATED ART

As optical systems shrink in size, there is a need to connect multiple optical paths within ever smaller spaces. Currently, optical circuits of an optical communication system, for example, typically are interconnected using assemblies of precisely-aligned optical fibers. As is known, these optical fibers are relatively fragile, cannot be formed to small radii of curvature, and generally require large connectors. Thus, reconfiguring such an optical circuit, i.e., interconnecting at least some of the optical paths in a different arrangement, is often time-consuming. This is especially problematic with respect to prototyping work, where the topologies of optical circuits may change frequently as a design is iterated.

In this regard, various adjustable optical switch configurations have been proposed. For example, U.S. Pat. No. 5,050,955 to Sjölinder, which is incorporated herein by reference, discloses a switch including a matrix block with light transmission devices that are arranged in rows and columns. The incoming optical fibers are arranged on slides which are inserted in guide grooves formed in the matrix block. Similarly, the outgoing optical fibers are arranged on slides which are inserted in guide grooves on the other side of the matrix block. This arrangement enables connections to be made selectively between the incoming and outgoing optical fibers by positioning the various slides.

U.S. Pat. No. 6,256,429 to Ehrfeld, et al., which is incorporated herein by reference, also discloses an optical matrix switch with slides. The input and output slides are fitted with stops and springs for aligning input and output optical fibers.

U.S. Pat. No. 5,841,917 to Jungerman, et al., which also is incorporated herein by reference, discloses an optical cross-connector switch incorporating a grid actuator. Optically reflective elements are attached to the ends of pins in the grid. The pins can be moved linearly in order to cause the reflective elements to redirect beams from the input fibers to the output fibers.

These conventional approaches to the problems discussed above suffer from a variety of perceived shortcomings. For example, it can be difficult to properly align the various fibers, sliders, and/or pins in order to provide adequate signal transmission. Therefore, it should be appreciated that there is a need for improved systems and methods that address these and/or other perceived shortcomings of the prior art.

### SUMMARY OF THE INVENTION

Optical systems and methods in accordance with the present invention selectively direct optical signals among multiple optical paths. Typically, this is accomplished by providing an array of waveguides. Optical couplers, which are moved by actuators, are used to interconnect and disconnect selected waveguides of the array optically.

An embodiment of an optical system in accordance with the invention includes a first waveguide and an optical coupler. The first waveguide propagates optical signals to a first location. The optical coupler incorporates first and second components and selectively, optically communicates with the first waveguide. In particular, the optical coupler is movable between an uncoupled position and a coupled position. In the coupled position, the optical coupler optically communicates with the first waveguide so that at least some of the optical signals from the first waveguide are redirected by the first component, then the second component, and then propagated to a second location that is different than the first location.

A method in accordance with the invention includes: providing an array of waveguides having a first group of waveguides arranged in a first plane and a second group of waveguides arranged in a second plane, the first plane being different than the second plane; propagating an optical signal through at least a portion of a first waveguide of the first group; providing an optical coupler including first and second components; and directing the optical signal to a second waveguide of the second group using the optical coupler.

Clearly, some embodiments of the invention may exhibit features and/or advantages in addition to, or in lieu of, those described here. Additionally, other systems, methods, features and/or advantages of the present invention will be or may become apparent to one with skill in the art upon examination of the following drawings and detailed description. It is intended that all such additional systems, methods, features and/or advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram depicting an embodiment of an optical system in accordance with the present invention.

FIG. 2 is a schematic diagram depicting the embodiment of FIG. 1, with the optical coupler in a first coupled position.

FIG. 3 is a flowchart depicting functionality of the embodiment of FIG. 1.

FIG. 4 is a schematic diagram depicting an embodiment of an optical coupler in accordance with the present invention.

FIG. 5 is a schematic diagram depicting a representative portion of an embodiment of an optical system in accordance with the invention, with the optical coupler of FIG. 4 shown in an uncoupled position.

FIG. 6 a schematic diagram depicting the optical system of FIG. 5, with the optical coupler in a first coupled position.

FIG. 7 is a schematic diagram depicting another embodiment of an optical coupler in accordance with the invention.

FIG. 8 is a schematic diagram depicting still another embodiment of an optical coupler in accordance with the invention.

FIG. 9 is a schematic diagram depicting a representative portion of an embodiment of an optical system in accordance with the invention, with the optical coupler of FIG. 8 shown in a first coupled position.

FIG. 10 is a schematic diagram depicting the optical system of FIG. 9, with the optical coupler of FIG. 8 shown in a second coupled position.

FIG. 11 is a schematic diagram depicting the optical system of FIGS. 9 and 10, with the optical coupler of FIG. 8 shown in a third coupled position.

FIG. 12 is a schematic diagram depicting the optical system of FIGS. 9-11, with the optical coupler of FIG. 8 shown in a fourth coupled position.

FIG. 13 is a flowchart depicting functionality of an embodiment of an optical system in accordance with the invention.

FIG. 14 is a schematic, plan view depicting an embodiment of an optical array in accordance with the invention.

FIG. 15 is a schematic, side view depicting the embodiment of the optical array of FIG. 14.

### DETAILED DESCRIPTION

As will be described in greater detail herein, optical systems in accordance with the invention selectively route optical signals among multiple waveguides. This is accomplished using optical couplers that communicate optically with one or more of the waveguides. By repositioning the optical couplers relative to the waveguides, propagation characteristics of such an optical system can be altered to re-route optical signals.

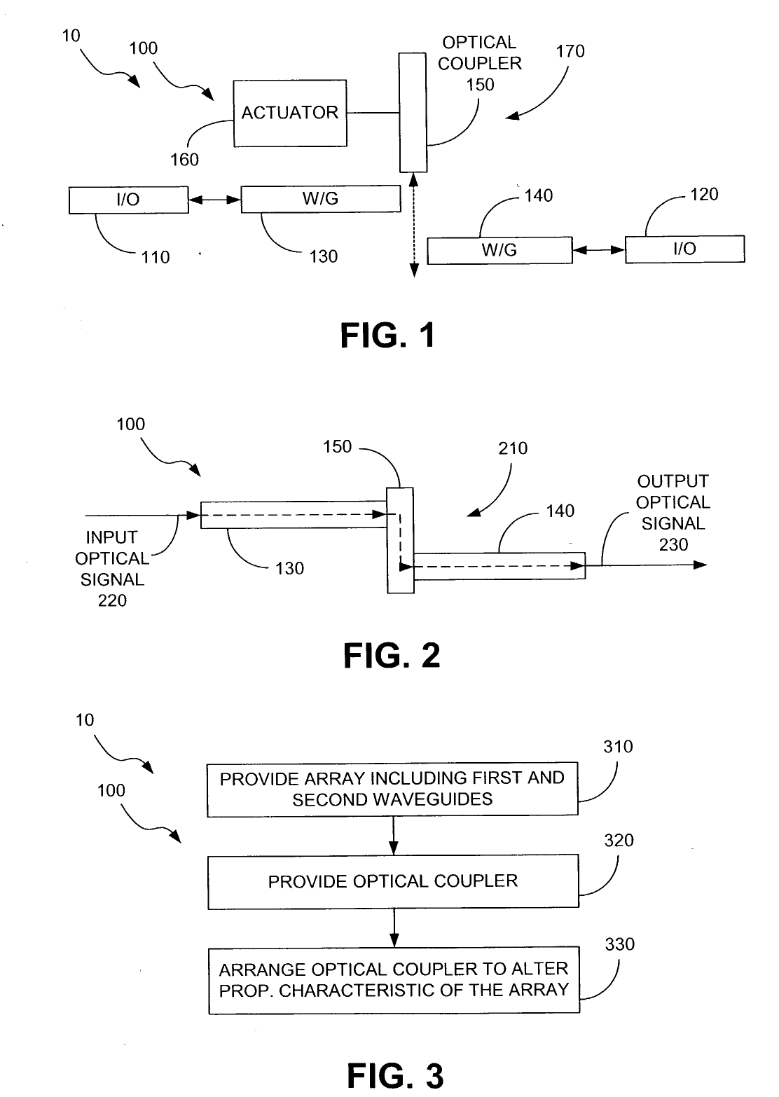

Referring now to the drawings, FIG. 1 is a schematic diagram depicting an embodiment of an optical system 10 in accordance with the present invention. As shown in FIG. 1, optical system 10 includes an optical interconnect assembly 100 that optically communicates with an input transmission medium 110 and an output transmission medium 120. More specifically, optical interconnect assembly 100 includes a first waveguide 130 that optically communicates with the input transmission medium 110, and a second waveguide 140 that optically communicates with the output transmission medium 120. Optical interconnect system 100 also includes an optical coupler 150 that communicates optically with neither, either or both of the waveguides depending upon its position. Optical engagement and disengagement of the optical coupler 150 with the waveguides is facilitated by an actuator 160.

Note, as depicted in FIG. 1, when the optical coupler does not optically engage the first and second waveguides, the first and second waveguides do not optically communicate with each other. As shown in FIG. 2, however, moving the optical coupler from an uncoupled position 170 (depicted in FIG. 1) to the coupled position 210 enables the first and second waveguides to communicate optically with each other. In particular, when the optical coupler is in the coupled position, an input optical signal 220 provided to the first waveguide is redirected with the optical coupler and provided to the second waveguide. In this embodiment, the second waveguide provides an output optical signal 230 that corresponds to the input optical signal. Clearly, moving the optical coupler so that it disengages at least one of the first and second waveguides can prevent an optical signal from propagating from the first waveguide to the second waveguide or vice versa.

Functionality of the embodiment of the optical system 10 depicted in FIGS. 1 and 2 and, in particular, the optical interconnect assembly 100, will now be described with respect to the flowchart of FIG. 3. As shown in FIG. 3, the functionality (or method) may be construed as beginning at block 310, where an array that includes a first waveguide and a second waveguide is provided. In block 320, an optical coupler also is provided. Thereafter, such as depicted in block 330, the optical coupler is arranged to communicate optically with one or more of the waveguides so that a propagation characteristic of the array is altered. For instance, by moving the optical coupler to the coupled position depicted in FIG. 2, an optical signal can be directed from the first waveguide to the second waveguide.

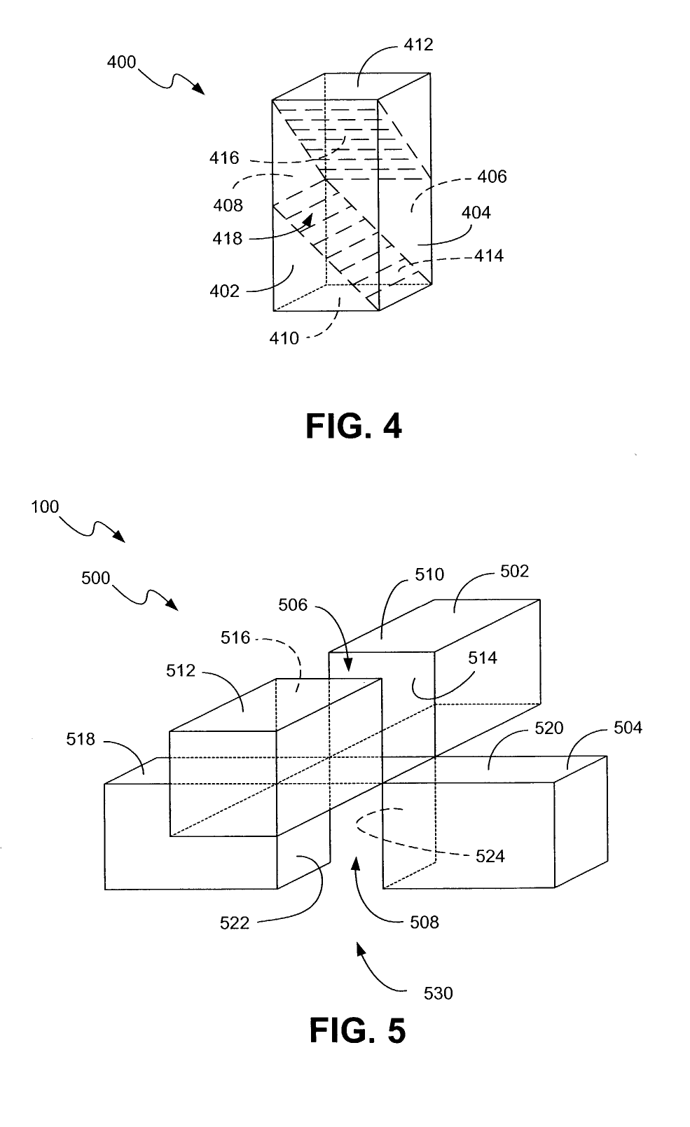

An embodiment of an optical coupler 400 is depicted schematically in FIG. 4. As shown in FIG. 4, optical coupler 400 includes sidewalls 402-408, each of which is generally rectangular in shape, and opposing basewalls 410 and 412, each of which also is generally rectangular in shape. Optical coupler 400 also includes components 414 and 416. Each of the components spans the interior 418 defined by the various walls, with each of the components being inclined with respect to at least one of the basewalls.

In particular, the components 414 and 416 are configured to receive an optical signal transmitted inwardly through a first of the walls and propagate a redirected optical signal outwardly through a second of the walls. Specifically, the embodiment of FIG. 4 receives an optical signal that is propagated through sidewall 404, re-directs the optical signal from the first component 414 to the second component 416, and then propagates the re-directed optical signal outwardly from the second component through sidewall 402. Clearly, the optical path traversed by the optical signal is bi-directional, i.e., the optical signal could enter through sidewall 402 and depart through sidewall 404. Note, each of the components 414 and 416 can be constructed to redirect optical signals by at least one of reflection, refraction and diffraction.

In other embodiments, optical couplers can include walls that are not rectangular in shape. Additionally, one or more of the components of an optical coupler may not span the interior of the optical coupler. For example, a component may exhibit a width that is shorter than that of the width of the optical coupler, as measured between opposing sidewalls. Further, with respect to directionality of optical signal propagation, embodiments of the optical coupler may exhibit other than bi-directionality. For instance, an optical coupler may propagate optical signals uni-directionally.

As mentioned before, optical couplers, such as optical coupler 400 of FIG. 4, typically facilitate optical communication between waveguides. In this regard, an embodiment of a waveguide assembly 500 that can use an optical coupler is depicted schematically in FIG. 5.

In FIG. 5, waveguide assembly 500 includes a first waveguide 502 and a second waveguide 504. Waveguide 502 defines a cavity 506 and waveguide 504 defines a cavity 508. In particular, cavity 506 divides waveguide 502 into two portions, i.e., portions 510 and 512, with the cavity 506 being defined by ends 514 and 516 of the respective waveguide portions. Similarly, cavity 508 divides waveguide 504 into two portions, i.e., portions 518 and 520, with the cavity 508 being defined by ends 522 and 524 of the respective waveguide portions. Note, in some embodiments, the cavity of a waveguide may not be provided in a size and/or shape that divides the waveguide into portions.

Waveguides 502 and 504 also overlie each other to form an overlap region 530. More specifically, cavity 506 overlies and is aligned with cavity 508. Note, each of the first and second waveguides are depicted as residing generally in planes that are oriented parallel to each other. Additionally, the waveguides overlie each other in a generally perpendicular arrangement. In other embodiments, however, the planes within which the waveguides are arranged may be other than parallel and/or the waveguides may not be provided in a generally perpendicular arrangement.

Based upon the materials selected for forming the waveguides 502 and 504 and the optical properties associated with the cavities 506 and 508, optical signals may either propagate or be prevented from propagating across a cavity from one waveguide portion to another waveguide portion. Clearly, selection of materials for forming the waveguides of a waveguide assembly and/or the optical properties of the cavities are to be based on the requirements of the particular application.

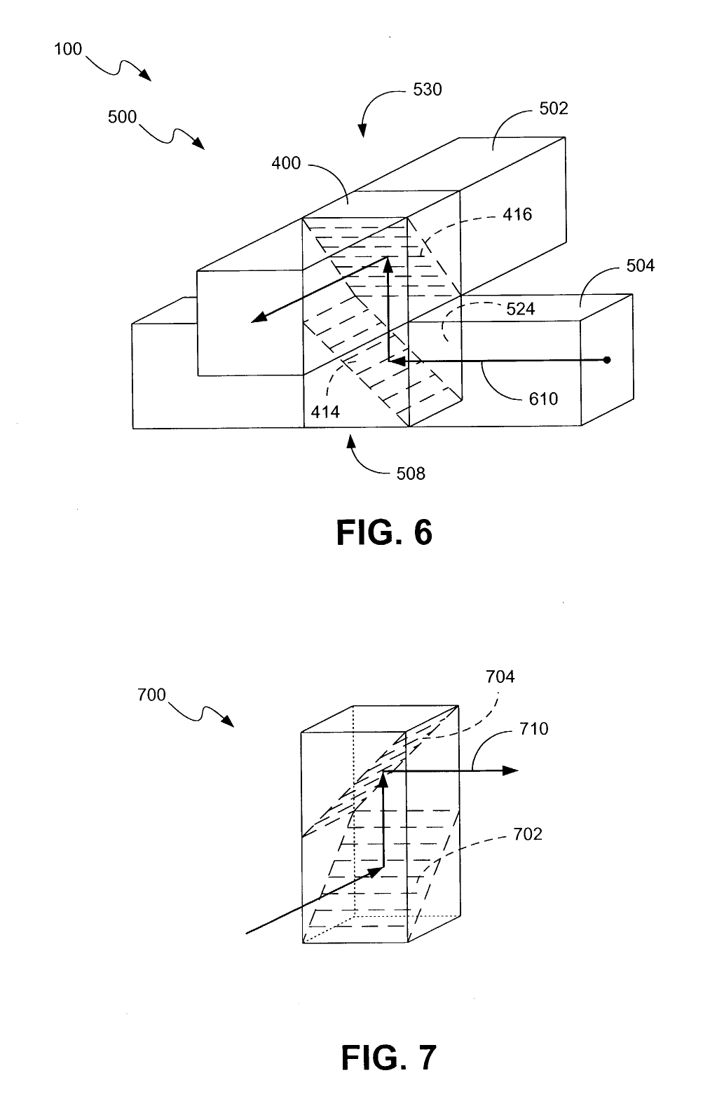

Referring now to FIG. 6, it is shown that an optical coupler can be used to facilitate selective optical communication between first and second waveguides. In particular, FIG. 6 schematically depicts engagement of an optical coupler 400 with the waveguides of waveguide assembly 500. More specifically, the optical coupler has been inserted into the overlap region 530 so that the first and second waveguides optically communicate with each other. By way of example, an optical signal 610 propagating through waveguide 504 is redirected by component 414. The optical signal then is directed to component 416, which redirects the optical signal for continued propagation along waveguide 502.

As mentioned before, in some embodiments, the waveguide assembly 500 can be adapted so that optical signals are prevented from traversing one or more of the cavities when an optical coupler is not engaged within the cavities. For example, if optical coupler 400 was disengaged from cavity 508 and optical signal 610 was directed toward the cavity, the optical signal could terminate at the interface of the waveguide and the cavity, e.g., at end 524. Thus, engagement of the optical coupler with the waveguide arrangement can enable an optical signal terminated within waveguide 504 to be redirected for continued propagation to waveguide 502.

In other embodiments, the waveguide assembly 500 can be adapted to enable optical signals to traverse one or more of the cavities when an optical coupler is not engaged within the cavities. For example, if optical coupler 400 was disengaged from cavity 508 and optical signal 610 was directed toward the cavity, the optical signal could propagate from waveguide portion 520, across the cavity, and continue propagating along waveguide portion 518. On the other hand, engagement of the optical coupler with the waveguide arrangement can enable the optical signal to be output from waveguide portion 512 of waveguide 502.

As another example, at least a portion of an optical coupler can be formed of an opaque material for preventing propagation of an optical signal. In such an embodiment, engagement of the optical coupler with the waveguide arrangement can disrupt propagation of an optical signal through the waveguide.

Component configurations other than that depicted in FIGS. 4 and 6 also can be used. For instance, as shown in FIG. 7, an optical coupler 700 can include components 702 and 704 that are adapted to direct optical signals in a manner different than that exhibited by optical coupler 400 of FIG. 4. In particular, optical coupler 700 provides an output optical signal 710 that is directed 180° out with respect to the output optical signal provided by optical coupler 400.

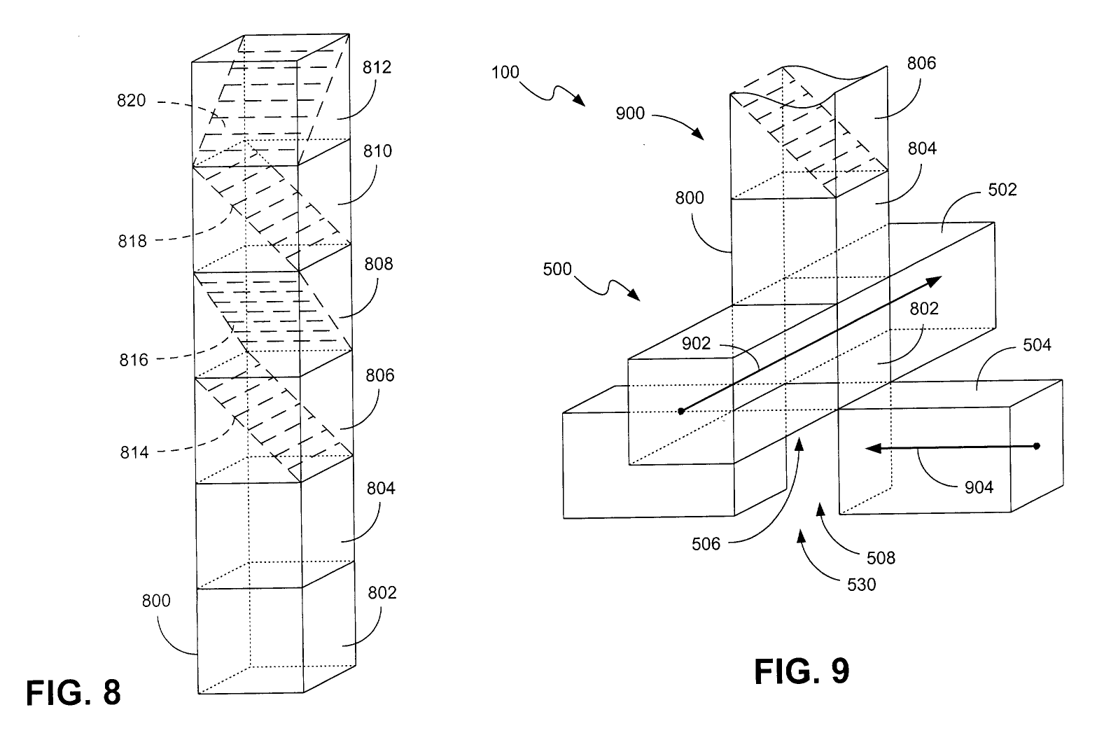

As shown in FIG. 8, optical couplers can be formed to include multiple sections, each of which can be adapted to alter propagation of optical signals in a different manner. In particular, optical coupler 800 of FIG. 8 includes six sections (802-812). More specifically, section 802 includes an optically transparent material, section 804 includes an optically opaque material, sections 806 and 808 include components 814 and 816, respectively, and sections 810 and 812 include components 818 and 820, respectively. Note, although each of the components may be used independently, some applications require the use of multiple components interacting with each other to produce a desired result. For instance, components 814 and 816 are arranged similar to the component configuration exhibited by optical coupler 400 of FIG. 4. Therefore, components 814 and 816 could be used together to redirect an optical signal as depicted in FIG. 6, for example.

Reference will now be made to FIGS. 9-12, which schematically depict operation of optical coupler 800 with an embodiment of a waveguide assembly. In particular, operation is described as the optical coupler is engaged with the waveguide assembly in various coupled positions. For ease of description, and not for the purpose of limitation, the waveguide assembly depicted in FIGS. 9-12 is similar to that depicted in FIGS. 5 and 6 and will not be described in detail again. As a point of contrast, however, optical signals , e.g., optical signal 902 propagating along waveguide 502 are able to traverse cavity 506 when the optical coupler is not engaged within the cavity, and optical signals, e.g., optical signal 904, propagating along waveguide 504 are prevented from traversing cavity 508 when the optical coupler is not engaged within cavity 508.

As shown in FIG. 9, optical coupler 800 is arranged in a first coupled position 900. In particular, first section 802 of the optical coupler is inserted within the cavity 506 so that the optical coupler optically communicates with waveguide 502. By being positioned in this manner, optical signal 902 propagating through waveguide 502 is substantially unaffected, i.e., the optical signal still is able to traverse cavity 506 and continue propagating along waveguide 502. Note, by engaging the first section 802 within cavity 506, mechanical engagement of the optical coupler within the cavity may tend to maintain alignment of the optical coupler 800 with the waveguide arrangement.

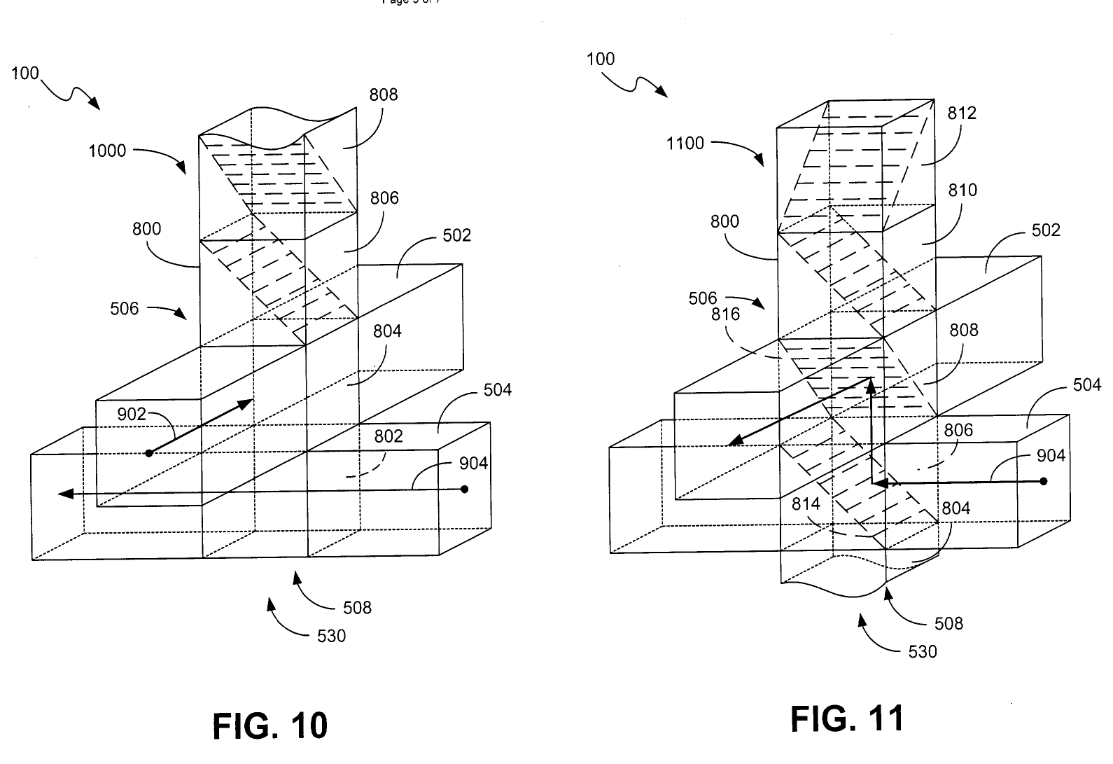

As shown in FIG. 10, optical coupler 800 is arranged in a second coupled position 1000. In particular, first section 802 and second section 804 of the optical coupler are inserted within overlap region 530 so that the optical coupler optically communicates with waveguides 502 and 504. In particular, first section 802 optically communicates with waveguide 504 and second section 804 optically communicates with waveguide 502. By being positioned in this manner, optical signal 904, which previously was prevented from traversing the cavity 508, is now enable to traverse the cavity and continue propagating along waveguide 504. Additionally, optical signal 902, which previously was able to traverse cavity 506, is prevented from traversing the cavity 506.

As shown in FIG. 11, optical coupler 800 is arranged in a third coupled position 1100. In particular, third section 806 and fourth section 808 of the optical coupler are inserted within overlap region 530 so that the optical coupler optically communicates with waveguides 502 and 504. In particular, third section 806 optically communicates with waveguide 504 and fourth section 808 optically communicates with waveguide 502. By being positioned in this manner, optical signal 904 is redirected from component 814, by component 816, and then provided to waveguide 502.

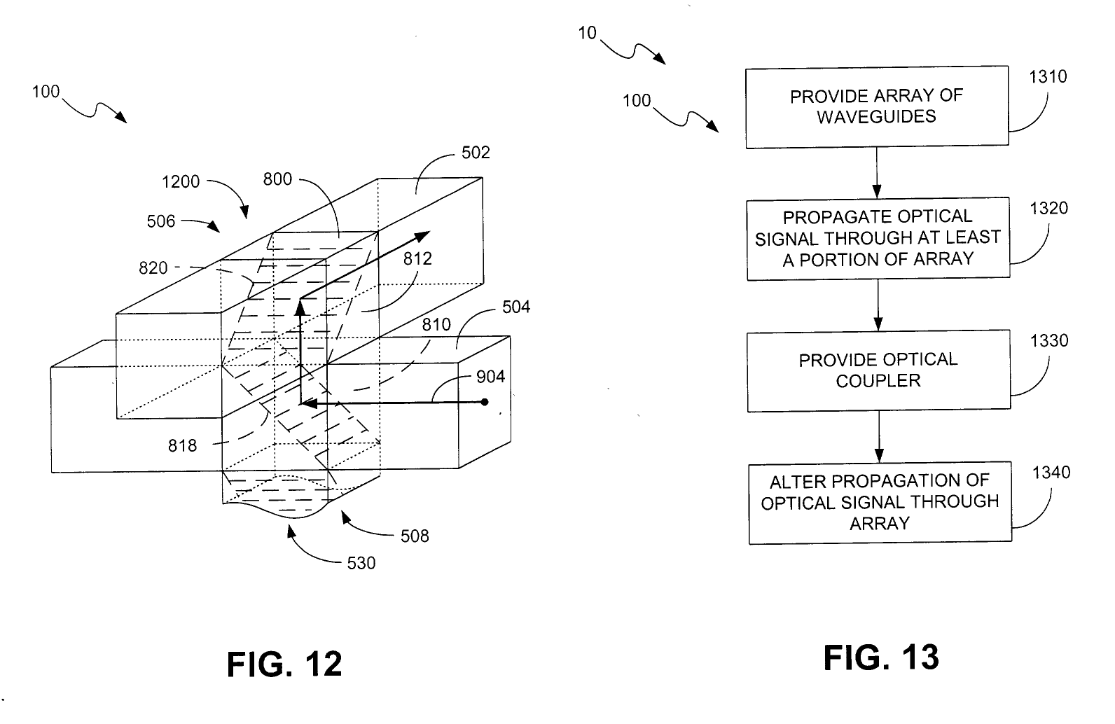

As shown in FIG. 12, optical coupler 800 is arranged in a fourth coupled position 1200. In particular, fifth portion 810 and sixth portion 812 of the optical coupler are inserted within overlap region 530 so that the optical coupler optically communicates with waveguides 502 and 504. In particular, fifth portion 810 optically communicates with waveguide 504 and sixth portion 812 optically communicates with waveguide 502. By being positioned in this manner, optical signal 904 is redirected from component 818, by component 820, and then provided to waveguide 502.

Note, when a component is positioned to communicate optically with a waveguide, the component may not be positioned to redirect optical signals propagating along that waveguide. For instance, optical coupler 800 could be arranged so that section 806 optically communicated with waveguide 502. In some embodiments, positioning a component in this manner may prevent propagation of an optical signal, e.g., optical signal 902, past the component. In other embodiments, at least a portion of the optical signal may be enabled to continue propagating past the component. Clearly, the propagation characteristics exhibited are based, at least in part, on the optical properties of the optical coupler, the component, and/or the optical signal.

Functionality of another embodiment of the optical system 10 and, in particular, the optical interconnect assembly 100, will now be described with respect to the flowchart of FIG. 13. As shown in FIG. 13, the functionality (or method) may be construed as beginning at block 1310 where an array of waveguides is provided. In block 1320 an optical signal is propagated through at least a portion of the array. In block 1330, an optical coupler is provided. Thereafter, such as depicted in block 1340, propagation of the optical signal through at least a portion of the array is altered.

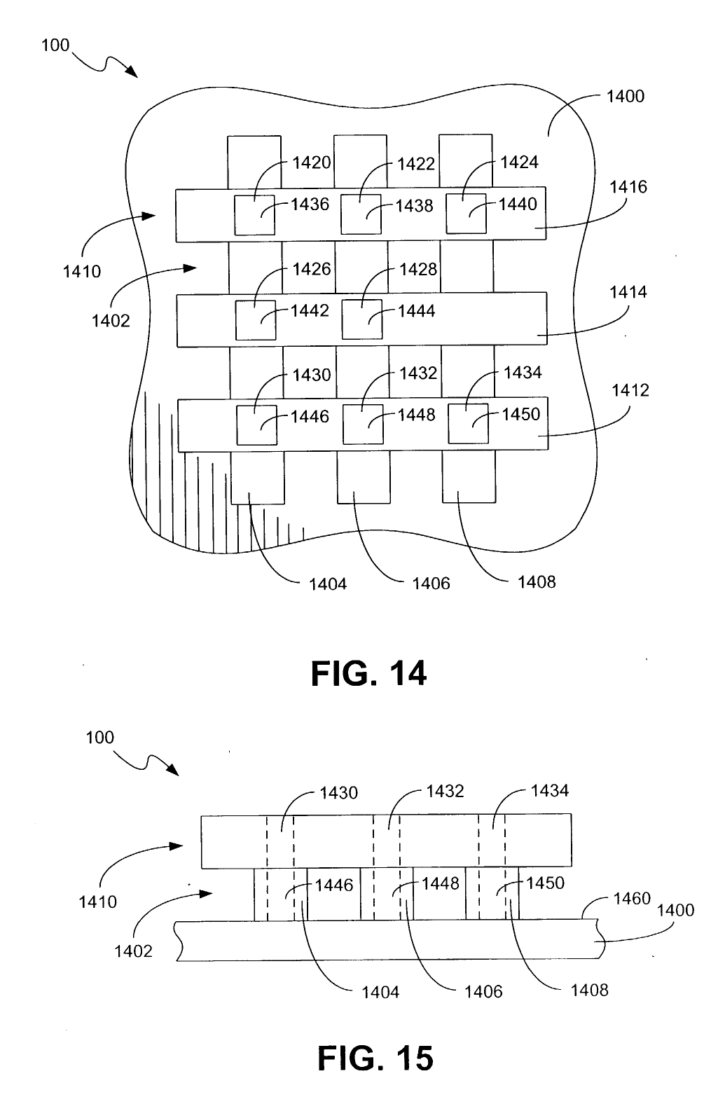

Reference is now made to FIGS. 14 and 15, which depict another embodiment of optical interconnect assembly 100 of the present invention that is configured as an array of waveguides. In particular, the assembly of FIGS. 14 and 15 can be used to implement the method of FIG. 13. In this regard, assembly 100 includes a substrate 1400 that supports a lower arrangement 1402 of waveguides, e.g., waveguides 1404-1408, and an upper arrangement 1410 of waveguides, e.g., waveguides 1412-1416. The waveguides of each arrangement are oriented substantially parallel to each other. More specifically, the waveguides of upper arrangement 1410 are arranged substantially parallel to each other, but substantially perpendicular to the waveguides of the lower arrangement 1402.

At least some of the waveguides define cavities, e.g., cavities 1420-1450, each of which is sized and shaped to receive at least a portion of an optical coupler (not shown). By using upper surface 1460 of substrate 1400, or another surface positioned at a known distance from the lower arrangement of waveguides, an optical coupler inserted downwardly through a cavity of the upper arrangement and then into a cavity of the lower arrangement can be accurately aligned with the corresponding waveguides. That is, the substrate can function as a stop for engaging an end of the optical coupler (not shown).

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated.

With respect to an array of waveguides, such as depicted in FIGS. 14 and 15, various ones of the waveguides may be interwoven to form a meshed grid. Various numbers of layers and/or interweaving patterns may be used. With respect to optical couplers, a component can be formed by trimming or cleaving the material of the optical coupler. All such modifications and variations are within the scope of the invention as determined by the appended claims.

1. An optical system comprising:
a first waveguide operative to propagate optical signals to a first location; and
an optical coupler selectively, optically communicating with the first waveguide, the optical coupler including a first component and a second component and being movable between an uncoupled position and a coupled position, in the coupled position the optical coupler optically communicating with the first waveguide such that at least some of the optical signals from the first waveguide are redirected by the first component, then the second component, and then propagated to a second location different than the first location.

2. The optical system of claim 1, further comprising:
a second waveguide arranged in a vicinity of the first waveguide; and
wherein, in the coupled position, the optical coupler enables at least some optical signals provided to the first waveguide to be directed to the second waveguide.

3. The optical system of claim 2, wherein the first waveguide has a first end and a second end; and
wherein the optical coupler is unidirectional such that, in the coupled position, only optical signals propagating through the first waveguide from the first end toward the second end are directed to the second waveguide.

4. The optical system of claim 1, wherein each of the first component and the second component redirect the optical signals by at least one of reflection, refraction and diffraction.

5. The optical system of claim 4, wherein the first waveguide defines a first cavity and the second waveguide defines a second cavity, each of the first cavity and second cavity being sized and shaped to receive at least a portion of the optical coupler; and
wherein the first cavity is aligned with the second cavity.

6. The optical system of claim 5, wherein, when the optical coupler is arranged within the first cavity and the second cavity in the coupled position, the optical coupler is oriented substantially perpendicular to each of the first and second waveguides.

7. The optical system of claim 5, wherein, when the optical coupler is not arranged in the coupled position, optical signals can propagate across the first cavity of the first waveguide.

8. The optical system of claim 5, wherein, when the optical coupler is not arranged in the coupled position, optical signals are prevented from propagating across the first cavity of the first waveguide.

9. The optical system of claim 1, further comprising:
an actuator operatively engaging the optical coupler, the actuator being operative to move the optical coupler selectively between the coupled position and the uncoupled position.

10. The optical system of claim 1, further comprising:
means for moving the optical coupler selectively between the coupled position and the uncoupled position.

11. The optical system of claim 1, wherein, in the uncoupled position, the optical coupler does not optically communicate with the first waveguide.

12. The optical system of claim 1, wherein the coupled position is a first coupled position; and
wherein the optical coupler includes an optically transparent portion corresponding to a second coupled position such that, when the optical coupler is arranged in the second coupled position, the first waveguide propagates optical signals to the first location.

13. The optical system of claim 1, wherein the coupled position is a first coupled position; and
wherein the optical coupler includes an opaque portion corresponding to a second coupled position such that, when the optical coupler is arranged in the second coupled position, the first waveguide is prevented from propagating optical signals to the first location.

14. The optical system of claim 1, further comprising:
a second waveguide and a third waveguide forming an array of waveguides with the first waveguide; and
wherein, in the coupled position, the optical coupler enables at least some optical signals provided to the first waveguide to be directed to at least one of the second waveguide and the third waveguide of the array.

15. The optical system of claim 14, wherein the first and second waveguides are arranged in a first plane, and the first and third waveguides are arranged in a second plane, the first plane being different than the second plane.

16. The optical system of claim 15, wherein the optical coupler is a first optical coupler, the first optical coupler enabling at least some of the optical signals of the first waveguide to propagate to the second waveguide when in the coupled position; and
further comprising:
a second optical coupler selectively, optically communicating with the first waveguide, the second optical coupler being movable between a second uncoupled position and a second coupled position, in the second coupled position the second optical coupler optically communicating with the first waveguide such that at least some of the optical signals of the first waveguide propagate to the third waveguide.

17. The optical system of claim 16, wherein the uncoupled and coupled positions of the first optical coupler are arranged substantially in the first plane; and
wherein the second uncoupled and second coupled positions of the second optical coupler are arranged substantially in the second plane.

18. The optical system of claim 17, wherein the first plane and the second plane are substantially orthogonal.

19. A method for directing optical signals comprising:
providing a first waveguide and a second waveguide;
propagating an optical signal through at least a portion of the first waveguide;
providing an optical coupler including a first component and a second component;
positioning the optical coupler in a first position to direct the optical signal to the second waveguide using the first component and the second component of the optical coupler; and
moving the optical coupler to a second position such that the optical signal is no longer directed to the second waveguide.

20. The method of claim 19, wherein, in using the first component and the second component to direct the optical signal to the second waveguide, each of the first component and the second component use at least one of reflection, refraction and diffraction to direct the optical signal.
